(19) United States
(12) Patent Application Publication
(10) Pub. No.: US 2007/0279512 A1
(43) Pub. Date: Dec. 6, 2007

(54) Imaging apparatus

(75) Inventors: Atsushi Maruyama, Sagamihara-shi (JP); Akira Yukitake, Tokyo (JP); Tetsuya Kokufu, Tokyo (JP); Daiki Yasumoto, Yokohama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Imaging Corp., Tokyo (JP)

(21) Appl. No.: 11/801,214

(22) Filed: May 9, 2007

(30) Foreign Application Priority Data
May 16, 2006 (JP) 2006-137062

(51) Int. Cl. H04N 5/222

(52) U.S. Cl. 348/333.11

(57) ABSTRACT

Disclosed is an imaging apparatus that simultaneously displays same movie images of different frame rates on respective windows of a multi window display part. An example of the imaging apparatus can be configured to comprise an image pickup device for imaging a subject, and a multi window display part capable of simultaneously displaying a plurality of movie images acquired from the image pickup device, wherein movie images to be displayed on the multi window display part are displayed on respective windows at different frame rates.

### CROSS REFERENCE TO RELATED APPLICATION

This application is based upon and claims the benefit of priority from prior Japanese Patent Application No. 2006-137062, filed on May 16, 2006, the entire contents of which are incorporated herein by reference.

### BACKGROUND OF THE INVENTION

1. Field of the Invention

The present invention relates to an imaging apparatus capable of changing the shooting parameters of a shooting mode.

2. Description of the Related Art

Recently, a lot of digital cameras having a plurality of shooting modes and a function of changing shooting parameters are on the market. There often are cases where a better image is acquired by changing the shooting mode and/or shooting parameters depending on the shooting conditions.

For example, the white balance is an example of the shooting parameters to be set. An ordinary camera has an auto white balance function to automatically adjust the white balance. The auto white balance is an automatic adjustment performed by image processing in such a way that a white object is shown white on a captured image even when a shot is taken under any light source. When the general colors in a screen are biased to a certain color, however, the white balance changes that biased color to be white, so that an image may not be recorded with a good hue always. As a solution to this shortcoming, some cameras have the mode of preset white balance in addition. In the preset white balance adjustment of such a camera, the values of a plurality of typical color temperatures are stored in the camera system as the center value data for white balance correction. The preset white balance function can also make it possible to select the value of the color temperature according to the light source that illuminates a subject, such as under clear sky, under cloudy sky, under an electric lamp or under a fluorescent lamp.

In changing shooting parameters, the effect of each parameter change is easily seen if a plurality of images processed with different shooting parameters are displayed at a time and compared with one another.

Japanese Patent No. 3139028 discloses a technique that allows an imaging apparatus to display a plurality of different images and records an image selected from those images on a recording medium. A plurality of images have different angles of view, focuses and exposures. The imaging apparatus of Japanese Patent No. 3139028 displays a plurality of shot images having different angles of view, focuses and exposures, and selectively records a desired one of the images.

### BRIEF SUMMARY OF THE INVENTION

The imaging apparatus of the present invention simultaneously displays same movie images of different frame rates in respective windows of a multi window display part.

As one configuration example, the imaging apparatus of the invention comprises an image pickup device for imaging a subject; and a multi window display part capable of simultaneously displaying a plurality of movie images acquired from the image pickup device, wherein movie images to be displayed on the multi window display part are displayed on respective windows at different frame rates.

The invention can provide an imaging apparatus which can allow a user to easily understand the effect of changing the shooting mode or a shooting parameter at the time of shooting a movie image, and easily and adequately select the function to be changed.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a block configuration diagram of an imaging apparatus according to a first embodiment of the invention;

FIG. 2 is a rear view of the imaging apparatus of FIG. 1;

FIG. 3 is a diagram of a display screen of a first hierarchical menu to be displayed on a display part when a MENU switch of the imaging apparatus of FIG. 1 is switched on;

FIG. 4 is a diagram of a display screen of a shooting menu to be displayed on the display part when the shooting menu in a second hierarchical menu is selected on the first hierarchical menu in FIG. 3;

FIG. 5 is a diagram of a multi window display screen of the display part when a frame rate is selected on the shooting menu in FIG. 4;

FIG. 6 is a diagram of a moving through-image of a full screen display when the frame rate of 30 frames/sec is selected in the display state in FIG. 5;

FIG. 7 is a timing chart of a movie image process in the imaging apparatus of FIG. 1;

FIG. 8 is a flowchart of a shooting/playback process (main routine) in the imaging apparatus of FIG. 1;

FIG. 9 is a flowchart of a sub routine “OK Switch Determination A” called in the main routine in FIG. 8;

FIG. 10 is a flowchart of a sub routine “OK Switch Determination B” called in the main routine in FIG. 8;

FIG. 11 is a diagram showing the display state of a shooting menu on a display part of an imaging apparatus according to a second embodiment of the invention; and

FIG. 12 is a flowchart of a shooting/playback process (main routine) in the imaging apparatus of FIG. 11.

### DETAILED DESCRIPTION OF THE PREFERRED EMBODIMENTS

Preferred embodiments of the invention are described below with reference to the accompanying drawings.

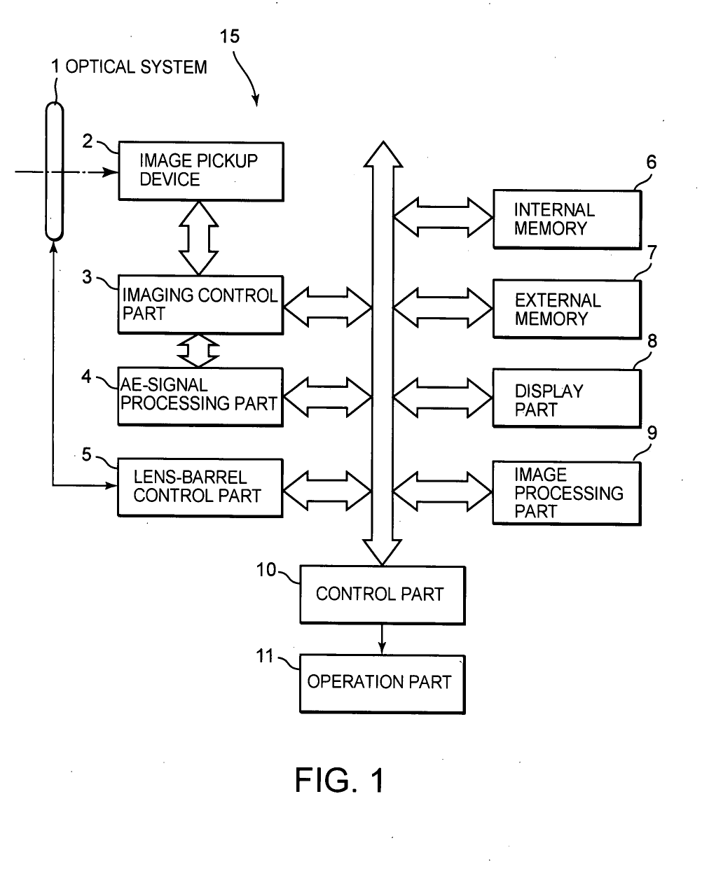

An imaging apparatus 15 of one embodiment of the invention is a digital camera capable of shooting a still image and a movie image. As shown in FIG. 1, the imaging apparatus 15 has a shooting optical system 1, a lens-barrel control part 5, an image pickup device 2, an imaging control part 3, an AE-signal processing part 4, an internal memory 6, an external memory 7, a display part 8, an image processing part 9, a control part 10 and an operation part 11.

The lens-barrel control part 5 moves a lens barrel holding the shooting optical system 1 back and forth to effect focusing and zooming. The image pickup device 2 is an imaging part which performs photoelectric conversion of a subject image captured through the shooting optical system 1. The imaging control part 3 controls the image pickup device 2 to process a photoelectrically-converted signal (imaging signal) to convert the imaging signal to a digital imaging signal. The AE-signal processing part 4 acquires subject luminance data based on the imaging signal from the image pickup device 2. The internal memory 6 temporarily stores image data from the image processing part 9 to be described later. The external memory 7 is a storage part, such as a memory card, detachably attached to the imaging apparatus 15 to record the image data. The display part 8 is an image display part (multi window display part) which fetches the image data, and displays a through-image (live movie image) before shooting, a shot movie image or still image, and shooting information. The display part 8 includes a TFT (Thin Film Transistor) drive control circuit and a TFT color liquid crystal. The image processing part 9 generates image data of a subject based on the imaging signal. The control part 10, connected to the aforementioned individual control elements by a bus line, performs the general control of the imaging apparatus 15. The operation part 11 includes operation switches, such as a shooting-mode setting switch and a release switch to instruct initiation of a shooting.

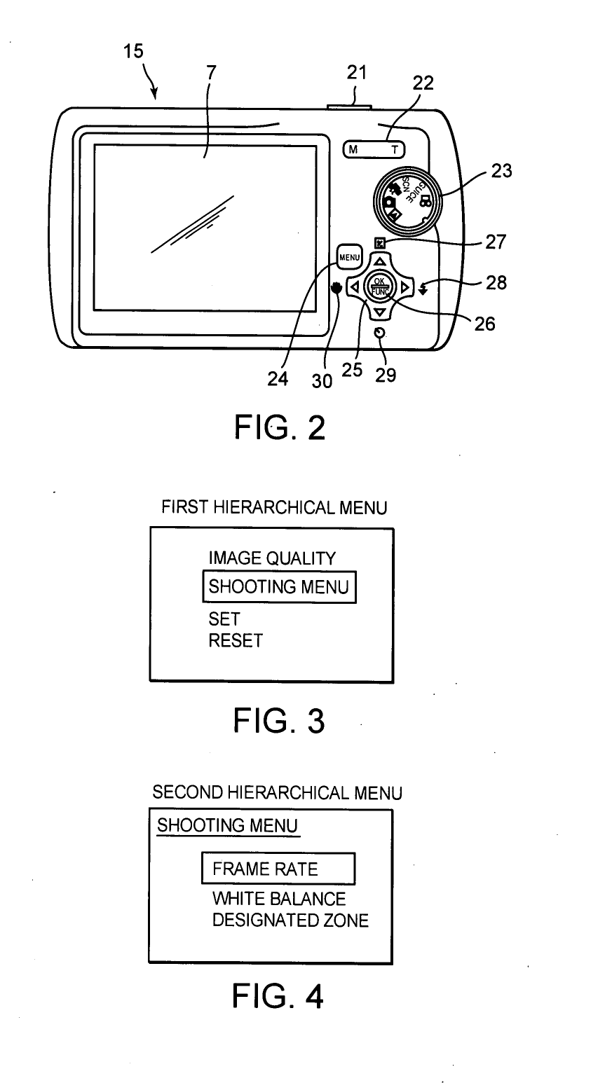

The display part 8 is located at the back side of the imaging apparatus 15 as shown in FIG. 2.

As shown in FIG. 2, the operation part 11 includes switches having operation buttons provided at the back side or the top side of the imaging apparatus 15. Specifically, the switches include a release switch 21 to instruct initiation of shooting, a zoom switch 22, a mode-setting dial switch 23, a MENU switch 24, an arrow pad switch 25, and an OK/FUNC switch 26.

The zoom switch 22 instructs zooming. The mode-setting dial switch 23 is a rotary switch for selecting a still-image shooting mode, a movie-image shooting mode, a playback mode, a camera-shake reduction shooting mode, and the like. The MENU switch 24 a menu setting screen on the display part 8. The arrow pad switch 25 has four switches for effecting exposure correction setting, flash setting, self-shooting mode setting, macro-shooting mode setting, moving the cursor with a menu setting screen displayed, and changing hierarchical menus from one to another. The OK/FUNC switch 26, located in the center portion of the arrow pad switch 25, is used to select and set a menu item with the menu setting screen displayed and change the mode to a function setting mode.

Indexes indicating set contents when the four directional switches are pressed are given at the four respective peripheral positions of the arrow pad switch 25. Specifically, there are an index 27 indicating an exposure correction setting position, an index 28 indicating a flash setting position, an index 29 indicating a self-shooting setting position, and an index 30 indicating a macro-shooting mode setting position.

When the MENU switch 24 of the imaging apparatus 15 with the above-described configuration is switched on, a first hierarchical menu which is transitional to any one of four menus shown in FIG. 3 is displayed on the display part 8.

The four menus are an image-quality menu, a shooting menu, a setting menu and a reset menu. The image-quality menu is used to set the image quality of an image to be shot. The shooting menu is used to set shooting conditions for various shooting modes to be described later. The setting menu is used to make various settings of the camera, such as selection of a display language and the built-in clock of the camera. The reset menu is used to initialize a shooting mode or the like set by a user. In the display state in FIG. 3, one of those menus is selected and set by operating the arrow pad switch 25 and the OK/FUNC switch 26.

With the shooting mode of the imaging apparatus 15 being set to movie image shooting, when the shooting menu is selected, a second hierarchical menu relating to the shooting menu shown in FIG. 4 is displayed on the display part 8.

The second hierarchical menu in FIG. 4 shows three shooting menus: frame rate menu for selecting a frame rate for shooting a movie image, white balance menu for setting the white balance, and digital zoom menu for setting the digital zoom.

The imaging apparatus 15 can select four types of frame rates. That is, 60 frames/sec (normal), 30 frames/sec, 15 frames/sec and 7 frames/sec are selectable. Note that the four rates are not restrictive and other rates can be used and selected as needed.

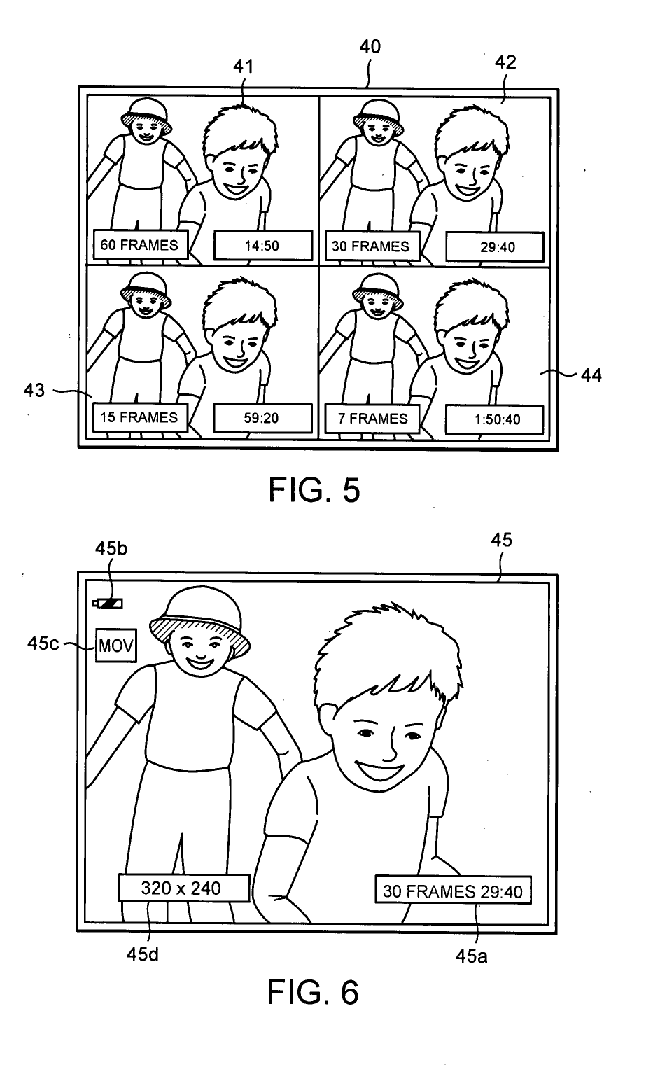

With the shooting menu in FIG. 4 being displayed, when the frame rate is selected by the operation of the arrow pad switch 25 and the OK/FUNC switch 26, a 4-split multi window 40 relating to the frame rate is displayed on the display part 8 (FIG. 5). The multi window 40 has moving through-images 41, 42, 43 and 44 of 60 frames/sec, frames/sec, 15 frames/sec and 7 frames/sec, respectively. The “frames/sec” and a recordable time at the frame rate for the currently remaining memory capacity of the external memory 7 are displayed below each split screen.

As one specific display example, a through-image of 60 frames/sec, “60 frames” and “14:50” (14 minutes and 50 seconds) are displayed on the split screen 41. A through-image screen of 30 frames/sec, “30 frames” and “29:40” are displayed on the split screen 42. A through-image screen of 15 frames/sec, “15 frames” and “59:20” are displayed on the split screen 43. A through-image screen of 7 frames/sec, “7 frames” and “1:58:40” (1 hour and 58 minutes and 40 seconds) are displayed on the split screen 44.

With the display part 8 being in the multi window display state in FIG. 5, the camera user can select a movie image of a single frame rate, which is preferred by the user or matches with the camera usage, from movie images of the four different frame rates by operating the arrow pad switch 25 and the OK/FUNC switch 26. When a movie-image on a through-image screen 45 of 30 frames/sec shown in FIG. 6 is selected, for example, the movie-image on the through-image screen 45 is displayed on the full screen of the display part 8. In addition to a display 45a indicating the frame rate and recordable time, an icon 45b indicating the remaining power in the battery, a movie mark 45c indicating that the movie-image mode is set, and an image-quality mode indicator 45d are displayed on the moving through-image 45 displayed fully.

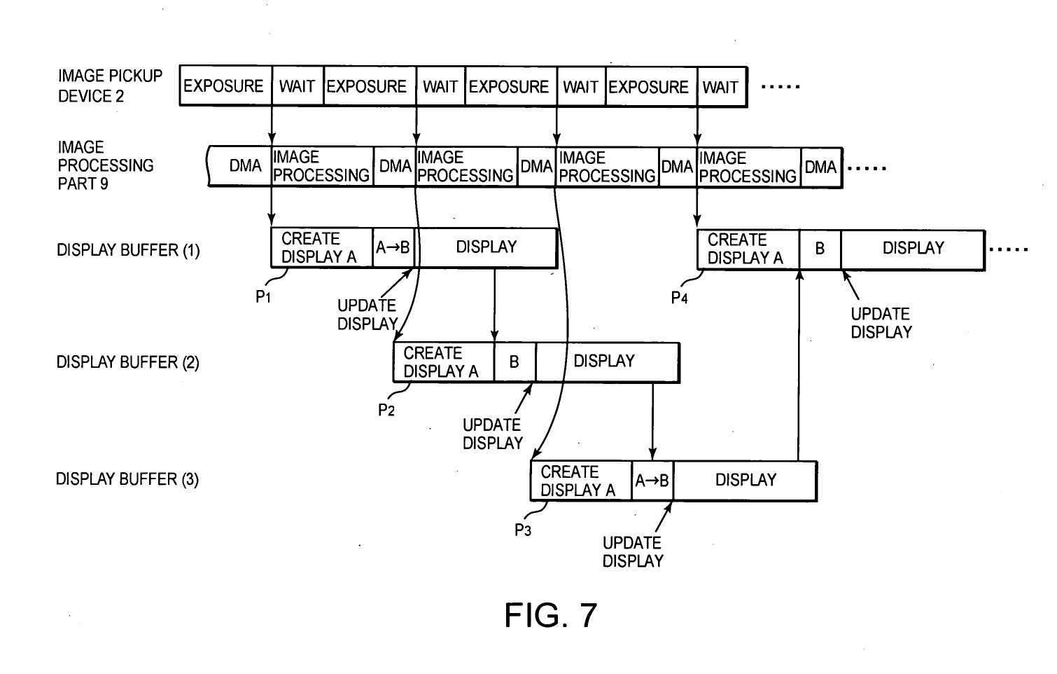

Using the timing chart for movie image processing in FIG. 7, a description will now be given of procedures of a process of displaying moving through-image of different frame rates on the multiple windows in the imaging apparatus 15 of the embodiment.

It is to be noted however that the following description of the process will be given of a case where two screens (image A and image B) are displayed on the display part 8 in a multi window style. In the case of the 4-screen multi window display in the embodiment, it is necessary to increase the number of display buffers and repeatedly update the displays for the respective frame rates.

As shown in FIG. 7, the image pickup device 2 repeats exposure and wait (wait time) every predetermined interval of the normal frame rate (60 frames/sec in the example of FIG. 5). An image signal acquired by the exposure is converted to digital data by the imaging control part 3 and is then transferred to the internal memory 6 to be stored therein. The image processing part 9 performs image processing, such as a white balancing, on the image stored in the internal memory 6. Working areas for display buffers (1), (2), (3) are provided in the internal memory 6.

Image data acquired by exposure is transferred to the display buffer (1) as an image (still image) P1 for displaying the image A. The image P1 is copied and recorded directly as an image for displaying the image B. The image P1 for displaying image A and the image P1 for displaying image B are simultaneously displayed in parallel on the display part 8.

Image data acquired by next exposure is transferred to the display buffer (2) as an image (still image) P2 for displaying the image A. Data of the image P1 for displaying image A in the display buffer (1) is transferred to the display buffer (2) as an image for displaying the image B. The image P2 for displaying image A and the image P1 for displaying image B are simultaneously displayed in parallel on the display part 8.

Image data acquired by subsequent exposure is transferred to the display buffer (3) as an image (still image) P3 for displaying the image A. The image P3 is copied and recorded directly as an image for displaying the image B. The image P3 for displaying image A and the image P3 for displaying image B are simultaneously displayed in parallel on the display part 8.

Image data acquired by next exposure is transferred to the display buffer (1) as an image (still image) P4 for displaying the image A. Data of the image P3 for displaying image A in the display buffer (3) is transferred to the display buffer (1) as an image for displaying the image B. The image P4 for displaying image A and the image P3 for displaying image B are simultaneously displayed in parallel on the display part 8.

Two-split multi window display with the image A of the normal frame rate and the image B of half the normal frame rate is repeated on the display part 8 in the above-described manner.

In the case of presenting the 4-screen multi window display for four frame rates as in the embodiment, as mentioned above, it is necessary to further increase the number of display buffers and repeatedly execute the aforementioned transfer and recording of image data.

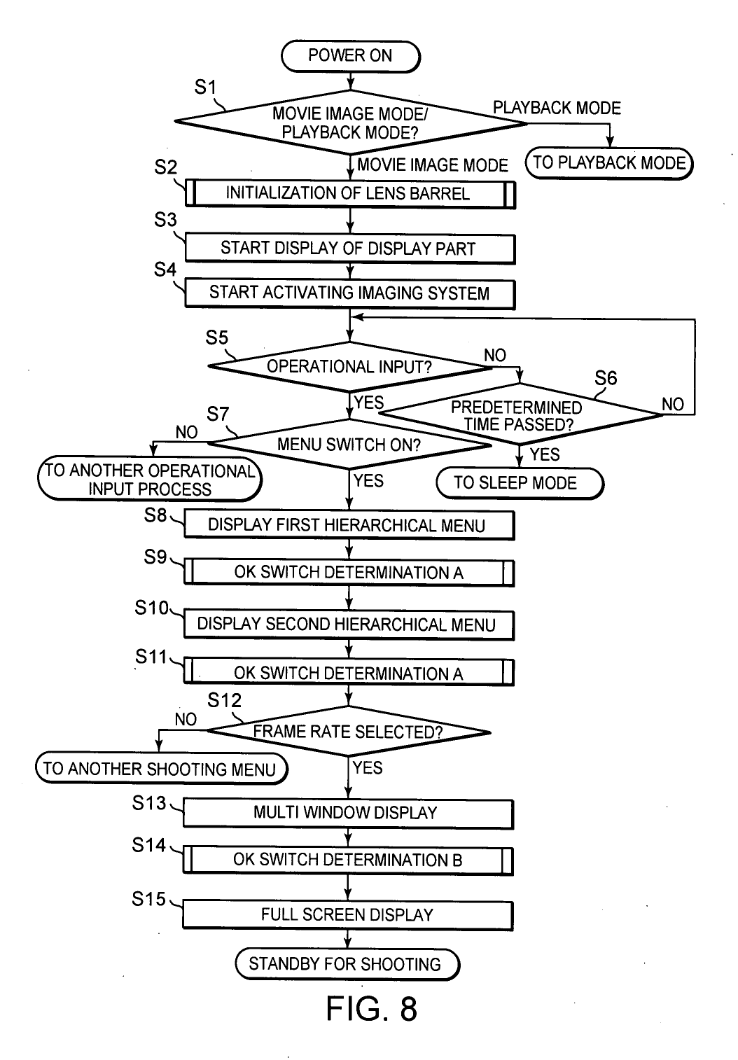

Next, a shooting/playback process including a multi window display/frame rate selecting process for movie images in the imaging apparatus 15 of the embodiment will be described referring to flowcharts in FIGS. 8 to 10.

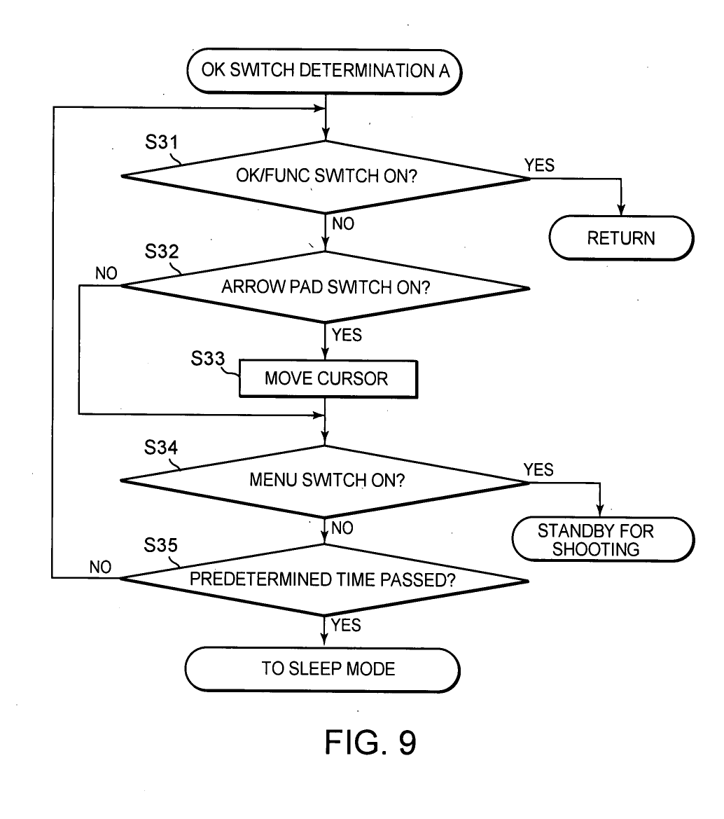

FIG. 8 is a flowchart of the shooting/playback process (main routine) in the imaging apparatus 15. FIG. 9 is a flowchart of a sub routine “OK Switch Determination A” called in the main routine in FIG. 8.

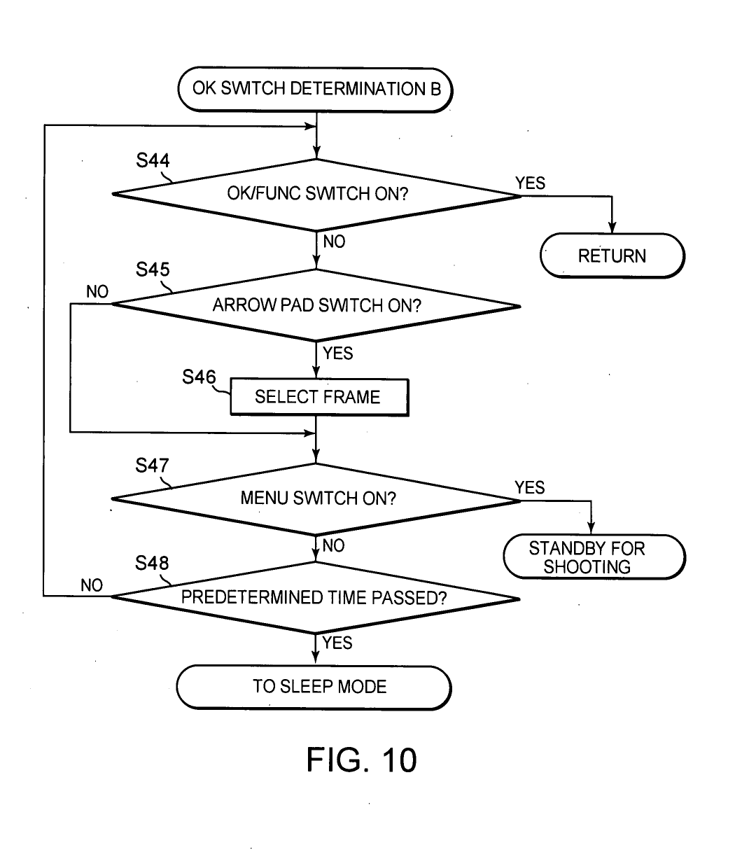

FIG. 10 is a flowchart of a sub routine “OK Switch Determination B” called in the main routine in FIG. 8.

First, as the power switch (not shown) of the imaging apparatus 15 is switched on, the shooting/playback process (main routine) in FIG. 8 starts according to the program stored in the internal memory 6 under the control of the control part 10. The shooting/playback process in FIG. 8 is executed when the imaging apparatus 15 is set in movie-image shooting/playback mode, whereas another shooting/playback process (not shown) is executed when the imaging apparatus 15 is set in still-image shooting/playback mode.

In step S1, it is determined whether the mode is set to the movie-image shooting mode or the movie-image playback mode. When the movie-image playback mode is set, a process for the playback mode takes place. When the movie-image shooting mode is set, the flow proceeds to step S2 where the lens barrel is protracted a shootable wide position and drive initialization of the lens barrel is executed to effect focusing. In step S3, display on the display part 8 is started. Further, in step S4, the imaging system including the image pickup device 2, the imaging control part 3 and the AE-signal processing part 4 becomes active, providing the shooting standby state.

In subsequent step 5, it is determined if an operational input is made through the operation part 11. When an operational input is made, the flow branches to step S7. When an operational input is not made, the flow branches to step S6.

In step S6, it is determined if a predetermined time has passed without any operational input made. In a case where an operational input is not made even when the predetermined time has passed, a sleep mode (power save mode) is set. When the predetermined time has not passed yet, the flow returns to step S5.

In step S7, it is determined whether the MENU switch 24 is pressed or not. When the MENU switch 24 is not pressed, another operational input process takes place. When the MENU switch 24 is pressed, the flow branches to step S8.

In step S8, the first hierarchical menu shown in FIG. 3 is displayed on the display part 8. The initial position of the cursor is at the position of “Shooting Menu”. The flow then proceeds to step S9 where the sub routine “OK Switch Determination A” (FIG. 9) is called. In this sub routine, as will be described later, it is determined whether the OK/FUNC switch 26 is pressed or not. In case “Shooting Menu” is selected by positioning the cursor on it, when the pressing of the OK/FUNC switch 26 is detected, the flow proceeds to step S10.

In step S10, the shooting menu is displayed on the display part 8 as the second hierarchical menu in FIG. 4. The initial position of the cursor is at the position of “Frame Rate”.

In step S11, the sub routine “OK Switch Determination A” (FIG. 9) is called again. When the pressing of the OK/FUNC switch 26 is detected, the flow proceeds to step S12.

In step S12, it is determined if “Frame Rate” is selected by the cursor position. When “Frame Rate” is selected, the image processing part 9 performs the image processing explained above referring to FIG. 7 based on an imaging signal acquired by the image pickup device 2 and the multi window 40 (FIG. 5) of plural frame rates is displayed on the display part 8 in step S13. Then, the flow proceeds to step S14. When “Frame Rate” is not selected, the flow branches to a process for another shooting menu other than the selection of the frame rate.

In step S14, the sub routine “OK Switch Determination B” is called. In this sub routine, as will be described later, it is determined if any one of windows in the multi window display state is selected and the OK/FUNC switch 26 is pressed. When the pressing of the OK/FUNC switch 26 is detected, the flow proceeds to step S15.

In step S15, a through-image (movie image) of the frame rate selected by the camera user is displayed on the full screen of the display part 8. For example, a through-image of 30 frames/sec as shown in FIG. 6 is displayed on the display part 8. Thereafter, the imaging apparatus 15 is in a standby mode for shooting a movie image at the selected frame rate.

The sub routine “OK Switch Determination A” which is called in the step S9, S11 (FIG. 8) will be described referring to a flowchart in FIG. 9.

When the sub routine “OK Switch Determination A” is called, it is determined in step S31 if the OK/FUNC switch 26 is pressed. When the OK/FUNC switch 26 is pressed, the flow directly returns to the main routine in FIG. 8. When the OK/FUNC switch 26 is not pressed, the flow branches to step S32.

In step S32, it is determined if the arrow pad switch 25 is pressed. When the arrow pad switch 25 is pressed, the flow proceeds to step S33. When the arrow pad switch 25 is not pressed, the flow jumps to step S34.

In step S33, the cursor on the first hierarchical menu in FIG. 3 or the cursor on the shooting menu in FIG. 4 is moved in the up and down direction, depending on the pressing direction of the arrow pad switch 25.

Subsequently, it is determined in step S34 if the MENU switch 24 is pressed. When the MENU switch 24 is pressed, a shooting standby process takes place. When the MENU switch 24 is not pressed, the flow branches to step S35.

In step S35, it is determined if a predetermined time has passed with no operational input made. In a case where an operational input is not made even when the predetermined time has passed, the sleep mode (power save mode) is set. When the predetermined time has not passed yet, the determination in step S31 is executed again.

The sub routine “OK Switch Determination B” which is called in the step S14 (FIG. 8) will be described referring to a flowchart in FIG. 10.

When the sub routine “OK Switch Determination B” is called, it is determined in step S44 if the OK/FUNC switch 26 is pressed. When the OK/FUNC switch 26 is not pressed, the flow branches to step S45. When the OK/FUNC switch 26 is pressed, the flow returns to step S15 in the main routine in FIG. 8 with a frame rate selected in step S46 to be described later (one of the frame rates of the windows 41-44 on the display screen of the multi window 40 in FIG. 5) being designated. When the OK/FUNC switch 26 is pressed in the initial operational stage, the flow returns to the main routine in FIG. 8 considering that the 60 frames/sec in FIG. 5 has been selected and designated.

In step S45, it is determined if the arrow pad switch 25 is pressed. When the arrow pad switch 25 is pressed, the flow proceeds to step S46. When the arrow pad switch 25 is not pressed, the flow jumps to step S47.

In step S46, the display state (display color or so) of one of the windows 41-44 on the display screen of the multi window 40 in FIG. 5 is changed and the frame rate is selected, depending on the pressing direction of the arrow pad switch 25.

In subsequent step S47, it is determined if the MENU switch 24 is pressed. When the MENU switch 24 is pressed, the shooting standby process takes place. When the MENU switch 24 is not pressed, the flow branches to step S48.

In step S48, it is determined if a predetermined time has passed with no operational input made. In a case where an operational input is not made even when the predetermined time has passed, the sleep mode (power save mode) is set. When the predetermined time has not passed yet, the determination in step S44 is executed.

As explained above, the imaging apparatus 15 of the embodiment displays movie images of different frame rates as shown in FIG. 5 in a 4-split multi window style as one of the shooting conditions in shooting a movie image. Even if the camera user is a novice, therefore, the user need not switch the screens from one to another and can easily understand the meaning of the frame rate of a movie image. This make it possible to select the movie-image shooting mode of the frame rate that provides the display effect matching with the motion of the subject and the user's preference and shoot a movie image.

Further, the recordable time for a movie image is acquired from the remaining capacity of the external memory 7 according to the frame rate and is displayed together with the frame rate. This makes it possible to meet the needs of the user in various cases, such as a case where the user wants to shoot a movie image for a long period of time even with a low frame rate or a case where the user wants to shoot a movie image at a high frame rate for the subject moves fast.

Although there are four selectable frame rates in the embodiment, which are not restrictive, other frame rates may be used as well.

In the multi window of the embodiment, images of different frame rates are displayed at a time on multiple windows at the time of selecting the frame rate for shooting a movie image. This is not restrictive, and a multi window screen display/selecting method similar to the above-described method can be used for shooting a still image. In this case, still images with different shooting conditions and shooting parameters can be displayed on the multi window screens at a time and a desired still image can be selected therefrom without switching the image display from one to another. This facilitates the operation for selecting a still image.

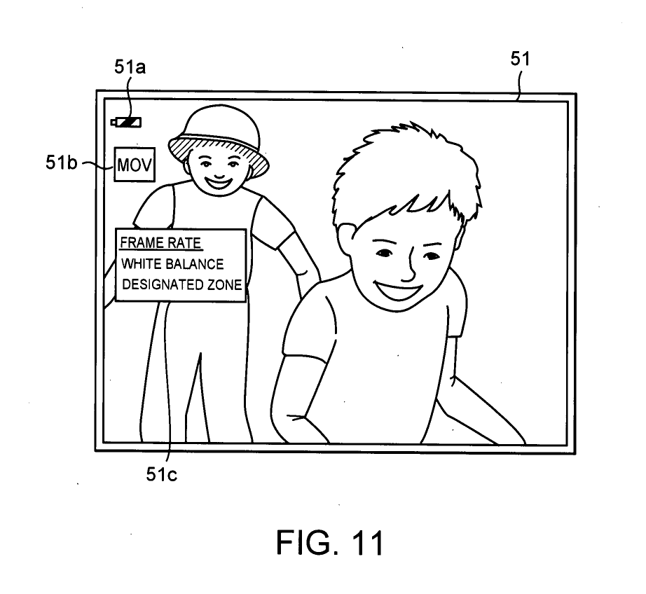

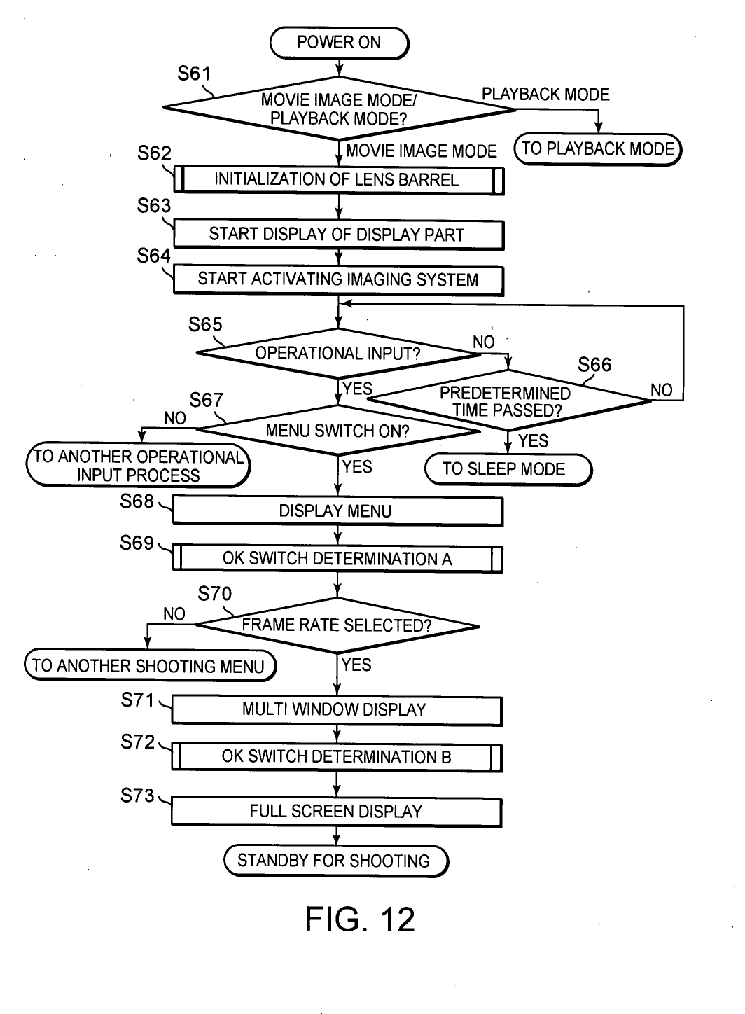

An imaging apparatus according to a second embodiment of the invention will be described referring to FIGS. 11 and 12.

FIG. 11 is a diagram showing the display state of the shooting menu or the second hierarchical menu on the display part of the imaging apparatus according to the embodiment of the invention. FIG. 12 is a flowchart of a shooting/playback process (main routine) in the imaging apparatus of the embodiment.

The imaging apparatus of the embodiment differs from the imaging apparatus 15 of the first embodiment only in the menu display state on the display part, and other structures or the like are the same as those of the imaging apparatus 15 of the first embodiment. The difference will be described below.

In the imaging apparatus of the embodiment, after the power switch is switched on, the first hierarchical menu (FIG. 3) which is displayed on the display part 8 in the first embodiment is not displayed thereon, but the second hierarchical menu (shooting menu) is displayed instead. A through-image of the normal frame rate is displayed as the screen image and the shooting menu is displayed, as a shortcut display, on the screen.

A shooting/playback process including a multi window display/frame rate selecting process for a movie image in the imaging apparatus of the embodiment will be described referring to a flowchart in FIG. 12.

First, as the power switch of the imaging apparatus of the embodiment is switched on, the shooting/playback process (main routine) in FIG. 12 starts according to the program stored in the internal memory 6 under the control of the control part 10. The shooting/playback process in FIG. 12, like the shooting/playback process of the first embodiment, is executed when the imaging apparatus is set in movie-image shooting/playback mode, whereas another shooting/playback process (not shown) is executed when the imaging apparatus 15 is set in still-image shooting/playback mode.

In step S61, it is determined whether the mode is set to the movie-image shooting mode or the movie-image playback mode. When the movie-image playback mode is set, a process for the playback mode takes place. When the movie-image shooting mode is set, the flow proceeds to step S62 where the lens barrel is protracted a shootable wide position and drive initialization of the lens barrel is executed to effect focusing. Thereafter, the same process up to step S4 in FIG. 8 in the first embodiment is executed until the imaging system becomes active in step S64 (shooting standby state).

In step S65, it is determined if an operational input is made through the operation part 11. When an operational input is made, the flow branches to step S67. When an operational input is not made, the flow branches to step S66 and the flow returns to step S65 until a predetermined time passes. When the predetermined time passes, the sleep mode takes place.

In step S67, it is determined if the MENU switch 24 is operated. When the MENU switch 24 is not operated, another operational input process takes place. When the MENU switch 24 is pressed, the flow branches to step S68.

In step S68, a shooting menu screen 51 shown in FIG. 11 is displayed. The shooting menu screen 51 has a shooting menu 51c displayed on a moving through-image of the normal frame rate as mentioned above. The initial position of the cursor is at the position of “Frame Rate”. In addition, an icon 51a indicating the remaining power in the battery and a movie mark 51b indicating that the movie-image mode is set are also displayed. The shooting menu display shows a white balance menu and a digital zoom menu in addition to a frame rate menu, so that those menus can be selected and set.

Subsequently, the flow proceeds to step S69 where the sub routine “OK Switch Determination A” (FIG. 9) is called. In this sub routine, it is determined whether the OK/FUNC switch 26 is pressed or not.

After Step 69, processes between step S70 and a shooting standby state of step S73 is executed in the same manner as the process from step S12 to step S15 in FIG. 8 in the first embodiment. Then, the full screen of the selected frame rate is displayed in step S73 after which the shooting standby state takes place.

The imaging apparatus of the embodiment brings about effects similar to those of the imaging apparatus 15 of the first embodiment, and displays the second hierarchical menu (shooting menu) directly from the shooting standby state, not the first hierarchical menu, after the shooting/playback process (main routine) starts. This makes it possible to quickly and directly select and designate the frame rate, white balance and digital zoom.

The imaging apparatus of the invention can be used as an imaging apparatus which can allow a user to easily understand the effect of changing the shooting mode or a shooting parameter at the time of shooting a movie image, and easily and adequately select the function to be changed.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. An imaging apparatus comprising:
an image pickup device for imaging a subject; and
a multi window display part capable of simultaneously displaying a plurality of movie images acquired from the image pickup device,
wherein movie images to be displayed on the multi window display part are displayed on respective windows at different frame rates.

2. The imaging apparatus according to claim 1, wherein each of the movie images consists of a plurality of still images picked up every predetermined interval, and a plurality of movie images to be displayed on the multi window display part are images acquired by thinning the original of the plurality of still images every predetermined interval.

3. The imaging apparatus according to claim 1, further comprising a storage medium for recording an image, wherein a recordable time of the storage medium is calculated and is displayed on each of the windows according to the plurality of movie images to be displayed on the multi window display part.

4. The imaging apparatus according to claim 1, wherein one window is selectable from the plurality of windows displayed on the multi window display part.

5. The imaging apparatus according to claim 1, wherein selection of the multi window display is enabled from a hierarchical menu.

6. The imaging apparatus according to claim 1, wherein selection of the multi window display is enabled directly in a shooting standby state.

7. A method of allowing a user to select a frame rate with an imaging apparatus, the method comprising:
generating a plurality of movie images of different frame rates by thinning images output from an image pickup device every predetermined interval;
setting a display part in a multi window display state to display the movie images of different frame rates on respective windows;
allowing the user to select a desired window by operating an operation part; and
canceling the multi window display state of the display part and displaying a movie image corresponding to a window selected by the user on a full display area.
